(19) United States
(12) Patent Application Publication
(10) Pub. No.: US 2025/0202567 A1
(43) Pub. Date: Jun. 19, 2025

(54) CONFORMANCE TESTING FOR A USER EQUIPMENT UNDER BLOCKAGE CONDITIONS

(71) Applicant: QUALCOMM Incorporated, San Diego, CA (US)

(72) Inventors: Vasanthan RAGHAVAN, West Windsor Township, NJ (US); Raghu Narayan CHALLA, San Diego, CA (US); Benjamin CHEADLE, San Diego, CA (US); Mohammad Ali TASSOUDJI, San Diego, CA (US)

(21) Appl. No.: 18/542,188

(22) Filed: Dec. 15, 2023

(51) Int. Cl. H04B 7/06; H04B 17/318; H04W 24/10; H04W 56/00

(52) U.S. Cl. CPC H04B 7/0696; H04B 17/328; H04W 24/10; H04W 56/0015

(57) ABSTRACT

Methods, systems, and devices for wireless communications are described. A user equipment (UE) may receive, from a network entity, beam-swept synchronization signals. The UE may select a first beam pair from a set of beam pairs associated with the set of beam-swept synchronization signals. The UE may perform one or more freespace spherical coverage measurements of a first antenna module based on selecting the first beam pair. The UE may calculate one or more blockage-impaired spherical coverage metrics of the first antenna module based on the one or more freespace spherical coverage measurements and a blockage transformation. The UE may calculate a predictive spherical coverage value of the UE in a blockage environment based on the one or more blockage-impaired spherical coverage metrics of the first antenna module and may calculate a conformance metric for the UE.

### TECHNICAL FIELD

The following relates to wireless communications, including conformance testing for a user equipment (UE) under blockage conditions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support conformance testing for a user equipment (UE) under blockage conditions. For example, the described techniques provide for a UE performing one or more freespace spherical coverage measurements (e.g., an equivalent isotropic radiated power (EIRP) or effective isotropic sensitivity (EIS)) for each antenna module of the UE based on receiving synchronization signals from a network entity, and predicting a cumulative spherical coverage value of the UE in a blockage environment based on the freespace spherical coverage measurements for each antenna module. For example, the UE may translate the freespace spherical coverage measurements for each antenna module to blockage-impaired spherical coverage metrics for each antenna module using one or more blockage transformation functions. The UE may average the blockage-impaired spherical coverage metrics for each antenna module to obtain the cumulative spherical coverage value of the UE, which may be predictive of a performance of the UE (e.g., an EIRP or EIS performance of the UE).

A method for wireless communications by a UE is described. The method may include receiving, from a network entity, a set of multiple beam-swept synchronization signals associated with a testing procedure for the UE, selecting a first beam pair from a set of multiple beam pairs associated with the set of multiple beam-swept synchronization signals, where the first beam pair corresponds to a first antenna module of the UE, performing one or more free-space spherical coverage measurements of the first antenna module based on selecting the first beam pair, the one or more free-space spherical coverage measurements including at least one of an EIRP or an EIS, calculating one or more blockage-impaired spherical coverage metrics of the first antenna module based on the one or more free-space spherical coverage measurements and a blockage transformation associated with the first antenna module, calculating a predictive spherical coverage value of the UE in a blockage environment based on the one or more blockage-impaired spherical coverage metrics of the first antenna module and one or more second blockage-impaired spherical coverage metrics of one or more other antenna modules of the UE, and calculating a conformance metric for the UE based on the predictive spherical coverage value of the UE in the blockage environment satisfying a threshold.

A UE for wireless communications is described. The UE may include one or more memories storing processor executable code, and one or more processors coupled with (e.g., operatively, communicatively, functionally, electronically, or electrically) the one or more memories. The one or more processors may individually or collectively operable to execute the code (e.g., directly, indirectly, after pre-processing, without pre-processing) to cause the UE to receive, from a network entity, a set of multiple beam-swept synchronization signals associated with a testing procedure for the UE, select a first beam pair from a set of multiple beam pairs associated with the set of multiple beam-swept synchronization signals, where the first beam pair corresponds to a first antenna module of the UE, perform one or more free-space spherical coverage measurements of the first antenna module based on selecting the first beam pair, the one or more free-space spherical coverage measurements including at least one of an EIRP or an EIS, calculate one or more blockage-impaired spherical coverage metrics of the first antenna module based on the one or more free-space spherical coverage measurements and a blockage transformation associated with the first antenna module, calculate a predictive spherical coverage value of the UE in a blockage environment based on the one or more blockage-impaired spherical coverage metrics of the first antenna module and one or more second blockage-impaired spherical coverage metrics of one or more other antenna modules of the UE, and calculate a conformance metric for the UE based on the predictive spherical coverage value of the UE in the blockage environment satisfying a threshold.

Another UE for wireless communications is described. The UE may include means for receiving, from a network entity, a set of multiple beam-swept synchronization signals associated with a testing procedure for the UE, means for selecting a first beam pair from a set of multiple beam pairs associated with the set of multiple beam-swept synchronization signals, where the first beam pair corresponds to a first antenna module of the UE, means for performing one or more free-space spherical coverage measurements of the first antenna module based on selecting the first beam pair, the one or more free-space spherical coverage measurements including at least one of an EIRP or an EIS, means for calculating one or more blockage-impaired spherical coverage metrics of the first antenna module based on the one or more free-space spherical coverage measurements and a blockage transformation associated with the first antenna module, means for calculating a predictive spherical coverage value of the UE in a blockage environment based on the one or more blockage-impaired spherical coverage metrics of the first antenna module and one or more second blockage-impaired spherical coverage metrics of one or more other antenna modules of the UE, and means for calculating a conformance metric for the UE based on the predictive spherical coverage value of the UE in the blockage environment satisfying a threshold.

A non-transitory computer-readable medium storing code for wireless communications is described. The code may include instructions executable by one or more processors (e.g., directly, indirectly, after pre-processing, without pre-processing) to receive, from a network entity, a set of multiple beam-swept synchronization signals associated with a testing procedure for the UE, select a first beam pair from a set of multiple beam pairs associated with the set of multiple beam-swept synchronization signals, where the first beam pair corresponds to a first antenna module of the UE, perform one or more free-space spherical coverage measurements of the first antenna module based on selecting the first beam pair, the one or more free-space spherical coverage measurements including at least one of an EIRP or an EIS, calculate one or more blockage-impaired spherical coverage metrics of the first antenna module based on the one or more free-space spherical coverage measurements and a blockage transformation associated with the first antenna module, calculate a predictive spherical coverage value of the UE in a blockage environment based on the one or more blockage-impaired spherical coverage metrics of the first antenna module and one or more second blockage-impaired spherical coverage metrics of one or more other antenna modules of the UE, and calculate a conformance metric for the UE based on the predictive spherical coverage value of the UE in the blockage environment satisfying a threshold.

In some examples of the method, UEs, and non-transitory computer-readable medium described herein, calculating the predictive spherical coverage value of the UE in the blockage environment may include operations, features, means, or instructions for performing an averaging of the one or more blockage-impaired spherical coverage metrics of the first antenna module and the one or more second blockage-impaired spherical coverage metrics of the one or more other antenna modules based on a set of multiple candidate hand or body positions associated with a user of the UE.

In some examples of the method, UEs, and non-transitory computer-readable medium described herein, each candidate hand or body position of the set of multiple candidate hand or body positions may be indicative of whether the first antenna module and each of the one or more other antenna modules may be in a blocked state.

In some examples of the method, UEs, and non-transitory computer-readable medium described herein, each candidate hand or body position of the set of multiple candidate hand or body positions corresponds to a respective probability and performing the averaging may be based on the respective probability of each candidate hand or body position.

Some examples of the method, UEs, and non-transitory computer-readable medium described herein may further include operations, features, means, or instructions for calculating a free-space uplink outage metric of the UE based on the one or more free-space spherical coverage measurements of the first antenna module, one or more second spherical coverage measurements of the one or more other antenna modules, and one or more path loss or link budget values associated with communication between the UE and the network entity and calculating a blockage-impaired uplink outage metric of the UE based on the one or more blockage-impaired spherical coverage metrics of the first antenna module, the one or more second blockage-impaired spherical coverage metrics of the one or more other antenna modules, and the one or more path loss or link budget values.

Some examples of the method, UEs, and non-transitory computer-readable medium described herein may further include operations, features, means, or instructions for calculating a second conformance metric of the UE based on a difference between the free-space uplink outage metric and the blockage-impaired uplink outage metric satisfying a second threshold.

In some examples of the method, UEs, and non-transitory computer-readable medium described herein, each of the one or more blockage-impaired spherical coverage metrics correspond to a respective portion of a spherical area surrounding the UE.

In some examples of the method, UEs, and non-transitory computer-readable medium described herein, the one or more blockage-impaired spherical coverage metrics include at least one of a second EIRP, different from the EIRP, or a second EIS, different from the EIS.

In some examples of the method, UEs, and non-transitory computer-readable medium described herein, selecting the first beam pair may include operations, features, means, or instructions for selecting the first beam pair based on the first beam pair having a relative highest average reference signal received power (RSRP) of the set of multiple beam pairs.

### BRIEF DESCRIPTION OF THE DRAWINGS

FIG. 1 shows an example of a wireless communications system that supports conformance testing for a user equipment under blockage conditions in accordance with one or more aspects of the present disclosure.

FIG. 2 shows an example of a wireless communications system that supports conformance testing for a user equipment under blockage conditions in accordance with one or more aspects of the present disclosure.

FIG. 3 shows an example of a flowchart that supports conformance testing for a user equipment under blockage conditions in accordance with one or more aspects of the present disclosure.

FIG. 4 shows an example of a process flow that supports conformance testing for a user equipment under blockage conditions in accordance with one or more aspects of the present disclosure.

FIGS. 5 and 6 show block diagrams of devices that support conformance testing for a user equipment under blockage conditions in accordance with one or more aspects of the present disclosure.

FIG. 7 shows a block diagram of a communications manager that supports conformance testing for a user equipment under blockage conditions in accordance with one or more aspects of the present disclosure.

FIG. 8 shows a diagram of a system including a device that supports conformance testing for a user equipment under blockage conditions in accordance with one or more aspects of the present disclosure.

FIGS. 9 and 10 show flowcharts illustrating methods that support conformance testing for a user equipment under blockage conditions in accordance with one or more aspects of the present disclosure.

### DETAILED DESCRIPTION

In some wireless communications systems, a network may configure specifications (e.g., requirements) for a user equipment (UE) to satisfy before the UE can be admitted to the network. The specifications may specify spherical coverage thresholds (e.g., equivalent isotropic radiated power (EIRP), effective isotropic sensitivity (EIS)) that the UE must meet. The spherical coverage thresholds may indicate a radiated power for a portion (e.g., 20%, 50%, 100%) of a spherical area/region surrounding/around the UE via which one or more signals transmitted by the UE may radiate. The UE may be tested for conformance to the spherical coverage thresholds while the UE communicates in a freespace environment with no (e.g., or relatively minimal) blockage, such as in a testing facility during manufacture or pre-deployment testing of the UE. However, a performance of the UE in a real-world environment may be impacted by blockage conditions, where objects may be proximal to the UE and may block or otherwise interfere with signals transmitted by the UE. Thus, existing conformance tests, which fail to account for the impact of blockage, may be insufficient in accurately assessing UE performance within a network.

In accordance with examples described herein, the UE may perform one or more enhanced conformance tests that test conformance of the UE to the spherical coverage thresholds (e.g., EIRP or EIS (EIRP/EIS) thresholds or specifications) while the UE communicates in a blockage environment. The UE may obtain spherical coverage measurements of the UE in the freespace environment for each antenna module of the UE individually. Based on the spherical coverage measurements for each antenna module in freespace conditions, the UE may calculate blockage-impaired spherical coverage metrics for each antenna module during a simulated blockage of the antenna module (e.g., using a freespace-to-hand blockage transformation function). The UE may calculate a predictive spherical coverage value of the UE in a blockage environment based on cumulating (e.g., averaging) the blockage-impaired spherical coverage metrics of the multiple antenna modules of the UE. In some cases, the blockage environment may be statistically averaged based on multiple candidate hand positions of a user of the UE. The UE may calculate a conformance of the UE to a spherical coverage threshold based on the predictive spherical coverage value of the UE in the blockage environment. In some examples, the UE may calculate an uplink outage metric of the UE in both the freespace and in the blockage environment, and a difference between the two outage metrics may indicate a conformance of the UE as measured with respect to an outage threshold.

Aspects of the disclosure are initially described in the context of wireless communications systems. Aspects of the disclosure are further described in the context of flowcharts and process flows. Aspects of the disclosure are further illustrated by and described with reference to apparatus diagrams, system diagrams, and flowcharts that relate to conformance testing for a user equipment under blockage conditions.

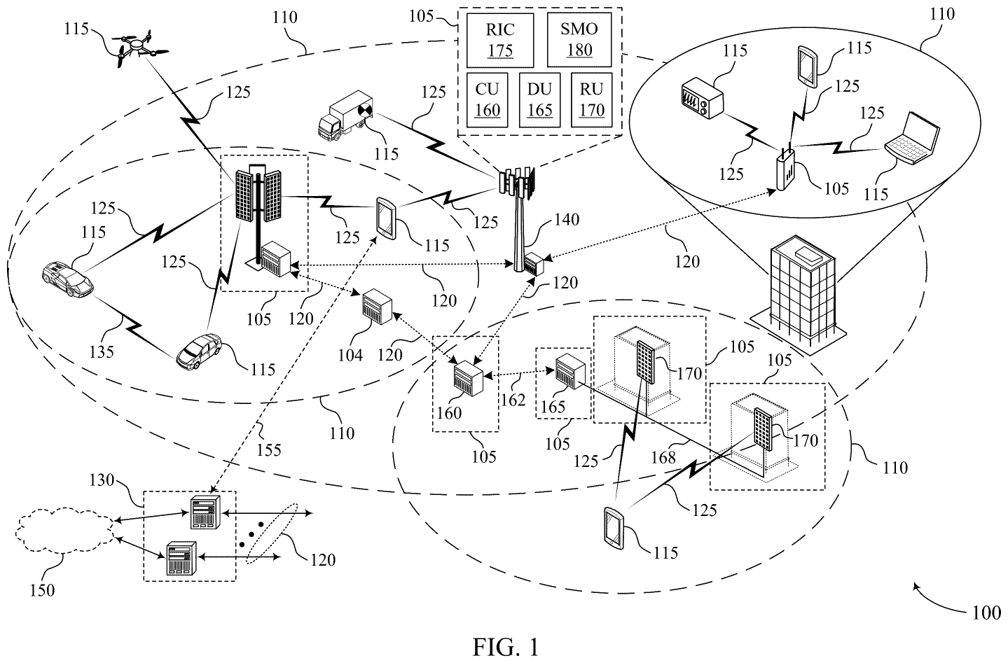

FIG. 1 shows an example of a wireless communications system 100 that supports conformance testing for a user equipment under blockage conditions in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (cNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support conformance testing for a user equipment under blockage conditions as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. cMTC and NB-IoT may refer to future technologies that may evolve from or may be based on these technologies. For example, eMTC may include FeMTC (further eMTC), cFeMTC (enhanced further cMTC), and mMTC (massive MTC), and NB-IoT may include eNB-IoT (enhanced NB-IoT), and FeNB-IoT (further enhanced NB-IoT).

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

A wireless communications device such as a UE 115 or network entity 105 may utilize multiple antennas for communications within a millimeter wave system or other high frequency communications system, such as the wireless communications system 100. Beamforming from multiple antennas may, in some examples, bridge the link budget in systems that have high traffic and operate using high frequencies. To realize beamforming gains due to multiple antennas, an analog or hybrid beamforming codebook is constructed and is typically stored in the radio frequency integrated circuit (RFIC) memory of the devices.

In some implementations, the wireless communications systems may evaluate signaling performance of devices. For example, target performance of a UE 115 may be specified in terms of spherical coverage metrics associated with EIRP/EIS across different radio frequency spectrum bands. Spherical coverage may be assessed by computing a coverage cumulative distribution function (CDF), where a UE 115 may demonstrate more than a threshold percentage (e.g., x %) of a spherical coverage region will have EIRP/EIS performance that meets a minimum performance threshold. In some cases, the peak (e.g., maximum) and percentile requirements for EIRP/EIS are specified for UEs 115 (across different UE power classes) across different bands. For example, a UE that meets these EIRP/EIS requirements may be referred to as an “admissible UE” under a given power class. In some cases, the specified performance thresholds may be implemented by a wireless communications standard, or by different network operators, each of which may have the same or different admissible performance thresholds. In some examples, network operators may have different (e.g., more stringent) requirements to admit UEs 115 into the network.

In some wireless communications systems, the network entity 105 may specify performance specifications (e.g., requirements) of the UE 115. The network entity 105 may utilize the performance specifications to filter multiple UEs 115 as to which of the multiple UEs 115 the network entity 105 may grant admittance into the network. For example, the network entity 105 may serve the UE 115 if the UE 115 meets the performance specifications or may not serve the UE 115 (e.g., may deny the UE 115 admittance into the network) if the UE 115 fails to meet the performance specifications. The network entity 105 may admit the UE 115 to the network based on a conformance testing procedure, by which the network entity 105 may determine that the UE 115 satisfies the performance specifications.

The network entity 105 may specify the performance specifications in the form of spherical coverage metrics associated with radiated power, such as an EIRP or an EIS. Radiated power specifications for uplink may be based on an EIRP, and radiated power specifications for downlink may be based on an EIS. The network entity 105 may indicate different radiated power specifications (e.g., radiated power thresholds) across different bands or for different UE power classes, for example, by indicating a respective radiated power specification for each band of a set of bands, for each UE power class of a set of UE power classes, or a combination thereof.

The UE 115 may estimate (e.g., calculate) a CDF of radiated power based on a set of signals that radiate around a spherical area surrounding the UE 115. The performance specifications may indicate different radiated power thresholds for different percentile points of the CDF. For example, the specifications may indicate a first radiated power threshold for a 100th percentile of the CDF (e.g., a peak performance), a second radiated power threshold for a 50th percentile of the CDF (e.g., a median performance), a third radiated power for a 20th percentile of the CDF (e.g., a tail performance), among other percentile points of the CDF. In some other examples, each of the first, second, and third radiated power thresholds may correspond to a respective portion (e.g., 100 percent, 50 percent, 20 percent) of a spherical area surrounding the UE 115 via which one or more signals transmitted by the UE 115 may radiate.

The radiated power specifications may apply for freespace or no blockage conditions. For example, the radiated power specifications may apply to conditions with no (e.g., or relatively minimal) blockage. Examples of a freespace or no blockage condition may include a testing over pre-deployment of the UE 115 in a chamber, or any space which lacks a presence of a human hand or other physical barrier that may at least partially block one or more antenna modules of the UE 115. The network entity 105 may thereby admit the UE 115 to the network based on satisfaction of the radiated power specifications during a testing procedure in freespace conditions (e.g., before deployment of the UE 115).

However, after the UE 115 is admitted into the network based on satisfaction of the radiated power specifications, a performance of the UE 115 may suffer due to various impairments associated with the UE 115 being located in or operating in a field different from the freespace operating conditions (e.g., in real-world applications, in blockage scenarios). For example, a performance of the UE 115 a may decrease or deteriorate, relative to the freespace condition, due to blockage from one or more objects in the field.

Enhanced blockage tests may be implemented for estimating the performance of millimeter wave UEs 115 under practical deployment considerations, such as under various different possible blockage conditions. For example, one possible performance test may estimate EIRP/EIS under different hand phantom conditions, or different positions that a user may manually hold a UE 115 (and possibly block one or more antenna modules of the UE 115). There may also be various/different kinds of blockage due to a high degree of flexibility in terms of electromagnetic properties of hand/body phantom materials, holding positions and measurement errors. To accurately measure performance under realistic conditions, EIRP/EIS may be measured under freespace conditions on a per-antenna module basis which can then be subsequently transformed using hand blockage models to produce EIRP/EIS under blockage conditions.

In some implementations, the wireless communications system 100 may support performance testing including a UE antenna module lock functionality (UMF). The antenna module lock may enable the network entity 105 (e.g., a testing device, a testing system) to instruct the UE 115 to utilize (e.g., test, communicate via) a single antenna module until the network entity 105 subsequently deactivates the antenna module lock. During a testing procedure, the network entity 105 may transmit a set of SSBs to the UE 115 as part of a beam sweep procedure, which the UE 115 may utilize in selecting a beam corresponding to a certain antenna module. The network entity 105 may transmit an antenna module lock command to the UE 115 to instruct the UE 115 to “lock” (e.g., not change) the antenna module of the UE 115. Upon the UE 115 locking the antenna module, the network entity 105 may transmit a beam lock command which may instruct the UE 115 to lock the selected beam at the selected antenna module. The UE 115 may then perform several performance measurements under the antenna module lock and the beam lock, and may report the measurements to the network entity 105. The UE 115 may then receive a beam lock deactivation to release or deactivate the beam lock. The UE 115 may then be repositioned according to a different orientation or a different directional plane, may perform another beam selection of a different beam, and may perform additional measurements under the antenna module lock. The UE 115 may move to several different locations (e.g., according to various orientations) while under the antenna module lock such that the UE 115 may collect and report measurements to evaluate spherical coverage for the selected antenna module (e.g., and corresponding beams). The UE 115 may then receive an antenna module lock deactivation command from the network entity 105 which may instruct the UE 115 to release the UE 115 antenna module lock. Upon releasing the antenna module lock, the UE 115 (e.g., and the network entity 105) may repeat the testing process to perform additional tests for other antenna modules of the UE 115.

In some examples, the UE 115 may receive, from a network entity 105, a set of beam-swept synchronization signals 205 (e.g., SSBs) associated with a testing procedure for the UE 115. The UE 115 may select a first beam pair from a set of beam pairs associated with the set of beam-swept synchronization signals 205. The first beam pair may correspond to a first antenna module of the UE 115. The UE 115 may perform one or more freespace spherical coverage measurements of the first antenna module based on selecting the first beam pair, and the one or more freespace spherical coverage measurements may include at least one of an EIRP or an EIS. The UE 115 may calculate one or more blockage-impaired spherical coverage metrics of the first antenna module based on the one or more freespace spherical coverage measurements and a blockage transformation associated with the first antenna module. The UE 115 may calculate a predictive spherical coverage value of the UE 115 in a blockage environment (e.g., under one or more blockage conditions) based on the one or more blockage-impaired spherical coverage metrics of the first antenna module and one or more second blockage-impaired spherical coverage metric of one or more other antenna modules of the UE. The UE 115 may calculate a conformance metric for the UE 115 based on the predictive spherical coverage value of the UE 115 in the blockage environment satisfying the threshold.

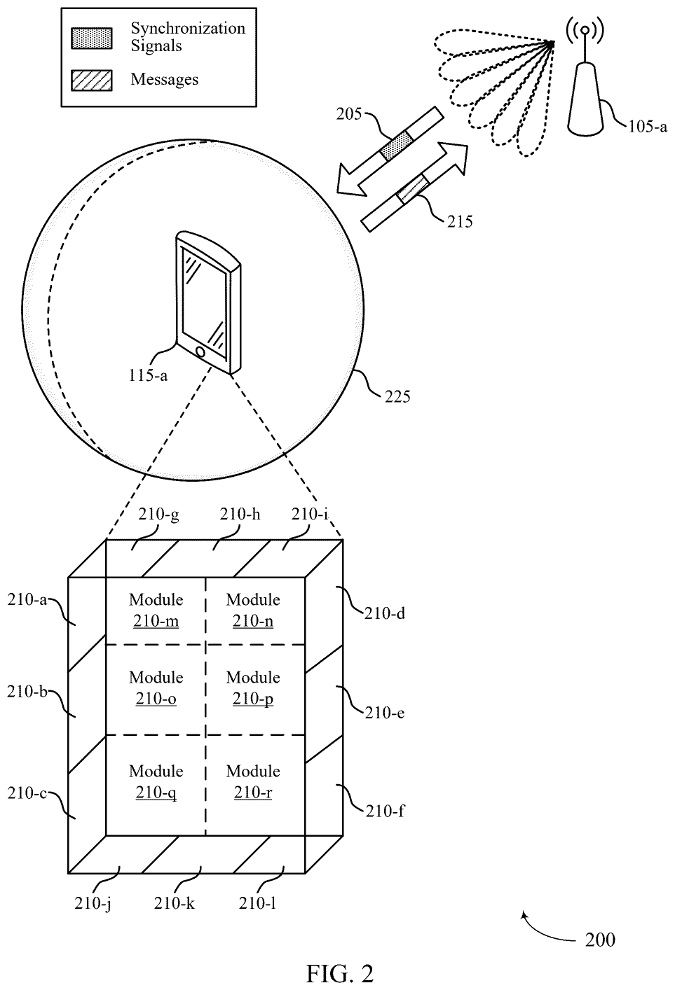

FIG. 2 shows an example of a wireless communications system 200 that supports conformance testing for a user equipment under blockage conditions in accordance with one or more aspects of the present disclosure. The wireless communications system 200 may implement aspects of the wireless communications system 100. For example, the wireless communications system 200 may include a network entity 105-a which may be an example of a network entity 105 as described with reference to FIG. 1, and both of which may be examples of testing equipment. The wireless communications system 200 may also include a UE 115-a that may be an example of a UE 115 as described with reference to FIG. 1.

The wireless communications system 200 may support different types of conformance testing, which may evaluate the performance of the UE 115-a and the network entity 105-a, including their ability to effectively transmit and receive signals and conform with various wireless communication standards. To evaluate signaling performance, the wireless communications system 200 may implement various testing procedures while the system is actively performing beam scanning and tracking. For example, one such testing procedure may include a “beam lock” functionality, which may allow the network entity 105-a to transmit a beam lock command that forces the UE 115-a to lock the beamforming pattern of the UE 115-a to a single beam such that testing may occur (and such that certain performance metrics may be evaluated) for the single locked beam.

The UE beam lock function may be implemented to evaluate different spherical coverage metrics associated with UE performance. In some cases, however, the overall performance of the UE 115-a may be a cumulative spherical performance metric of the UE 115-a over all of the individual antenna modules of the UE 115-a (e.g., over one or more antenna modules 210 of the UE 115-a such as a first antenna module 210-a and a second antenna module 210-b). While a cumulative spherical performance metric may indicate to the network entity 105-a whether the UE 115-a is (on average) performing above various thresholds (e.g., corresponding to EIRP/EIS requirements, among others), the cumulative performance metric may not evaluate the performance of individual antenna modules of the UE 115-a. That is, the cumulative performance metrics may be skewed to represent the best performing antenna module, but may not be able to effectively identify any antenna modules that may be performing below a threshold performance metric. In order to more granularly evaluate the performance for each individual antenna module, the wireless communications system 200 may implement testing techniques to determine performance of each antenna module of the UE 115-a.

For example, during a testing procedure, the network entity 105-a may transmit one or more messages 215 to the UE 115-a. The one or more messages 215 may include a set of beam swept SSBs. The UE 115-a may perform beam selection using the SSBs, and may select a beam pair based on the beam pair having a highest relative reference signal received power (RSRP) of all the beam swept SSBs. The selected beam pair may also correspond to a certain antenna module of the UE 115-a based on, for example, the relative position of the UE 115-a or other factors. For example, the UE 115-a may select a beam associated with the first antenna module 210-a. In some examples, the UE 115-a may indicate the selected beam pair to the network entity 105-a.

After initial beam selection, the UE 115-a may perform various measurements for the selected beam at the first antenna module 210-a, including EIRP/EIS, among other conformance tests and spherical test metrics. In some examples, the measurements may include testing various characteristics of beams across different locations of a sphere 225 to evaluate a signal strength at the first antenna module 210-a. For example, each position of the UE 115-a may correspond to a different angle over a spherical coverage region located around the UE 115-a (e.g., the device under test). The EIRP/EIS measurements (corresponding to receiver side automatic gain control (AGC)) that correspond to each position of the sphere 225 may be collected to evaluate a complete performance metric for the UE 115-a. Upon completing the measurements, the UE 115-a may transmit the measurement results to the network entity 105-a.

After performing the measurements for the selected beam, the UE 115-a may be repositioned for one or more other measurements. For example, the UE 115-a may be moved to a different location within a testing area such that additional measurements may be performed for the antenna module 210-a. In such cases, the network entity 105-a may respond to the received measurements by transmitting a beam lock deactivation (e.g., release) command to the UE 115-a to release the first selected beam, while retaining an antenna module lock on the first antenna module 210-a in the different location. The UE 115-a may move to one or more different locations (e.g., according to various orientations) during a repositioning operation, where the UE 115-a may move in one or more lateral directions, may rotate about one or more axes or angles, or a combination thereof. After repositioning, and while the antenna module lock for the antenna module 210-a remains activated, the UE 115-a may select a different beam, receive a second beam lock for the different beam, and may take one or more measurements for the different beam to evaluate spherical coverage for the first antenna module 210-a (e.g., and corresponding beam(s)). The UE 115-a may continue to perform measurements using the described process for the first antenna module 210-a until the UE 115-a obtains a full spherical coverage metric of EIRP, EIS, or both, at the first antenna module (e.g., the UE 115-a may use the measurements to plot a CDF for EIRP and EIS of the first antenna module 210-a).

The UE 115-a may then perform one or more measurements (e.g., repeat the process) for another antenna module (e.g., the second antenna module 210-b). For example, the network entity 105-a may transmit one or more other messages to the UE 115-a instructing the UE to deactivate an antenna module lock on the first antenna module 210-a. The UE 115-a may then be repositioned such that the UE 115-a selects a beam pair corresponding to the second antenna module 210-b. The network entity 105-a may then transmit a second module lock command for the UE 115-a to lock the second antenna module 210-b. The network entity 105-a and the UE 115-a may then repeat the processes (e.g., the locking and unlocking of beams for the second antenna module 210-b, beam lock deactivations and activations at the second antenna module 210-b) so that the UE 115-a can evaluate the performance of the second antenna module 210-b and overall spherical performance during the antenna module lock activation of the second antenna module 210-b.

The UE 115-a may obtain freespace EIRP/EIS measurements for each antenna module 210 at the UE. For example, the UE 115-a may obtain freespace EIRP/EIS measurements independently for the antenna module 210-a, the antenna module 210-b, and an antenna module 210-c, which may be located at the left edge of the UE 115-a, for an antenna module 210-d, an antenna module 210-c, and an antenna module 210-f, which may be located at a right edge of the UE 115-a, for an antenna module 210-g, an antenna module 210-h, and an antenna module 210-i, which may be located at a top edge of the UE 115-a, for an antenna module 210-j, an antenna module 210-k, and an antenna module 210-l, which may be located at a bottom edge of the UE 115-a, and for an antenna module 210-m, an antenna module 210-n, an antenna module 210-o, an antenna module 210-p, an antenna module 210-q, and an antenna module 210-r, which may be located at a back face of the UE 115-a. In contrast to the EIRP/EIS measurements in freespace with all modules 210 in the UE 115-a (e.g., the DUT) turned on, the UE 115-a may obtain the freespace EIRP/EIS measurements with one of the modules 210 turned on and the remainder of the modules 210 turned off. The UE 115-a may perform such measurements using a beam-lock mechanism, an antenna module lock mechanism, or other measurement mechanisms enabling the UE 115-a to obtain per-antenna module EIRP/EIS measurements.

Based on the per-antenna module freespace EIRP/EIS measurements, the UE 115-a may perform offline processing of the freespace EIRP/EIS measurements to obtain a hand blockage prior-cumulated EIRP/EIS measurement (e.g., CDF) of the UE 115-a. For example, a known set of hand blockage (e.g., or hand/body blockage) transformations may convert the freespace EIRP/EIS measurements from freespace to a hand blockage environment (e.g., a hand blockage mode or hand blockage condition) to obtain blockage-impaired EIRP/EIS values for each antenna module 210.

The UE 115-a may determine a set of hand or body (hand/body) positions (e.g., hand hold positions) of a user of the UE 115-a. The set of hand/body positions may be preconfigured at the UE 115-a or indicated to the UE 115-a by the network entity 105-a. Each hand/body position may have a respective probability, which may be based on a typical behavior of a user of the UE 115-a, for example, using one or more hand/body position models. Each hand/body position may induce either of a no blockage performance or a blockage performance for each antenna module 210 based on a location of the antenna module 210. For example, a first hand/body position may block an antenna module 210-j, an antenna module 210-k, an antenna module 210-l, and an antenna module 210-c, and may not block the remaining antenna modules 210. In another example, for a second hand/body position, the antenna module 210-g, the antenna module 210-a, and the antenna module 210-m may be in a blocked state, and the remaining antenna modules 210 may be in an unblocked state. The first hand/body position may correspond to a different probability relative to the second hand/body position. The set of hand/body positions, and respective probabilities of each hand/body position, may replicate on-filed performance of the UE 115-a in a presence of hand blockage (e.g., in a blockage environment). In other words, the set of hand/body positions and the probabilities of each hand/body position may simulate a blockage environment for the UE 115-a.

In some examples, the UE 115-a may perform conformance tests of the UE 115-a in a blockage environment by comparing the prior-cumulated EIRP/EIS value of the UE with an EIRP/EIS specification or threshold. In some examples, the UE 115-a may reuse existing EIRP/EIS specification for freespace conditions. Additionally, or alternatively, the UE 115-a may use EIRP/EIS specifications different from existing EIRP/EIS specifications for freespace conditions. By comparing the prior-cumulated EIRP/EIS value of the UE (e.g., in the simulated blockage-environment) to the EIRP/EIS thresholds, the UE 115-a may determine that the UE 115-a satisfies the EIRP/EIS thresholds, and that the UE 115-a passes the conformance test, or that the UE 115-a fails to satisfy the EIRP/EIS thresholds, and that the UE 115-a fails the conformance test.

In some implementations, the UE 115-a may combine the EIRP/EIS data (e.g., the CDF) of the UE in freespace with path loss data (e.g., a path loss distribution or model) to estimate an uplink outage probability of the UE 115-a in freespace. The UE 115-a may also combine the EIRP/EIS data (e.g., CDF, prior-cumulated EIRP/EIS value) of the UE in blockage with path loss data to (e.g., a path loss distribution or model) to estimate an uplink outage probability of the UE 115-a in a blockage condition or blockage environment. The uplink data that the UE 115-a uses to estimate the uplink outage metric (e.g., the uplink outage probability) of the UE 115-a may be deployment dependent, and may be based on an established connection between the UE 115-a and the network entity 105-a. For example, the path loss data may be based on a characteristic or parameter of the network entity 105-a, a channel quality between the UE 115-a and the network entity 105-a, a distance between the UE 115-a and the network entity 105-a, a frequency range for communication between the UE 115-a and the network entity 105-a, or a combination thereof.

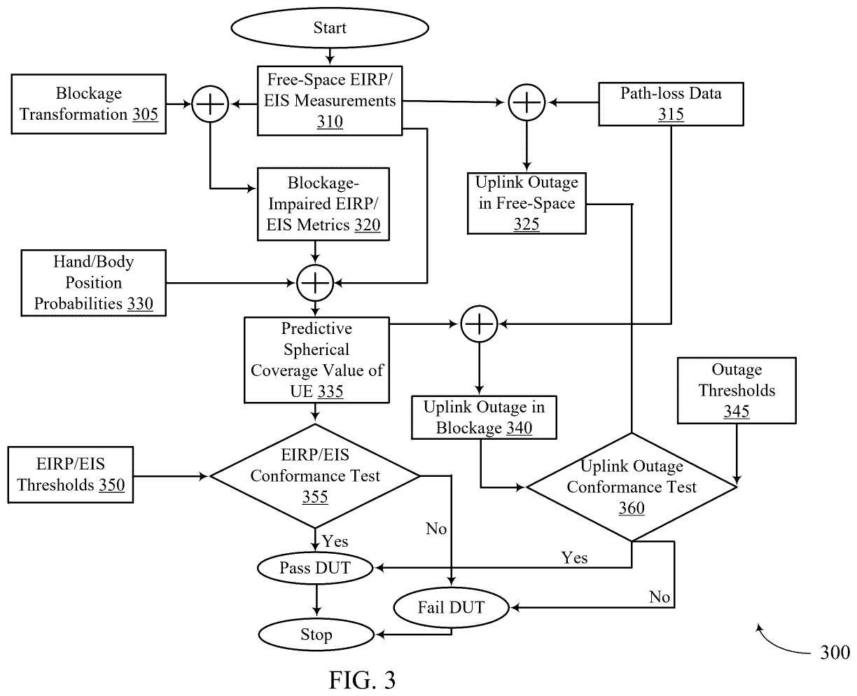

FIG. 3 shows an example of a flowchart 300 that supports conformance testing for a user equipment under blockage conditions in accordance with one or more aspects of the present disclosure. The flowchart 300 may implement aspects of the wireless communications system 100 or the wireless communications system 200. For example, the flowchart 300 may include steps performed by a UE 115-a during one or more conformance tests of the UE 115-a.

A UE may obtain freespace EIRP/EIS measurements 310 of each antenna module of the UE over a sphere surrounding the UE. For example, the UE may obtain the EIRP/EIS measurements at different percentile points of a CDF that correspond to different portions of a spherical area surrounding the UE. The UE may input the freespace EIRP/EIS measurements 310 to a blockage transformation function 305 to obtain blockage-impaired EIRP/EIS metrics 320. The blockage transformation function 305 may include one or more mathematical functions that estimate the impact of hand/body blockage to an EIRP/EIS performance of an individual antenna module at the UE.

The UE may use the blockage-impaired EIRP/EIS metrics for each antenna module at the UE, in combination with hand/body position probabilities 330, to obtain a predictive spherical coverage value 335 of the UE (e.g., a prior-cumulated EIRP/EIS value of the UE). For example, the UE may perform an averaging of the blockage-impaired EIRP/EIS metrics 320 with each hand/body position probability corresponding to a respective antenna module of the UE to obtain a cumulated EIRP/EIS performance of the UE under blockage conditions. Some hand/body positions may be associated with a relatively higher probability (e.g., a probability of occurrence) than some other hand/body positions. Accordingly, the hand/body positions associated with the relatively higher probability may be assigned a relatively greater weight in the averaging. That is, the UE may assign a weight to each blockage-impaired EIRP/EIS metric based on a probability that the respective antenna module is blocked in non-freespace conditions. The cumulated average of the hand/body position probabilities may correspond to an estimated blockage condition of the UE in a field environment. Thus, the predictive spherical coverage value of the UE may be a predictive EIRP/EIS value of the UE in simulated blockage environment.

The UE may perform the EIRP/EIS conformance test 355 by comparing the predictive spherical coverage value 335 of the UE with EIRP/EIS thresholds 350. The EIRP/EIS thresholds 350 may be preconfigured at the UE (e.g., may be indicated to the UE by a network entity). The EIRP/EIS thresholds 350 may be the same as EIRP/EIS thresholds used to test the UE for conformance in a freespace condition (e.g., in a chamber, during manufacture without any blockage). The UE (e.g., DUT) may pass the EIRP/EIS conformance test 355 if the predictive spherical coverage value 335 satisfies the EIRP/EIS thresholds 350 (e.g., is greater than the EIRP/EIS thresholds 350), and the UE may fail the EIRP/EIS conformance test 355 otherwise.

In some examples, the UE may combine the freespace EIRP/EIS measurements 310 with path loss data 315 to determine an uplink outage metric 325 of the UE in free space. The UE may also combine the predictive spherical coverage value 335 of the UE in a blockage environment with the path loss data 315 to obtain an uplink outage metric 340 of the UE in a blockage environment. The uplink outage metric 325 of the UE in free space and the uplink outage metric 340 of the UE in a blockage environment may correspond to a probability of an uplink outage at the UE. The path loss data 315 may be a path loss model or a path loss distribution, and the path loss data 315 may be based on an indoor deployment of the UE, an outdoor deployment of the UE, or a combination thereof. In some examples, the UE may perform an uplink outage conformance test 360. The uplink outage conformance test 360 may calculate a difference between the uplink outage metric 340 in a blockage environment and the uplink outage metric 325 in free space. The UE (e.g., DUT) may pass the uplink outage conformance test 360 if the difference between the uplink outage metric 340 and the uplink outage metric 325 satisfies (e.g., is greater than) outage thresholds 345, and the UE may fail the uplink outage conformance test 360 otherwise. In some examples, the outage thresholds 345 may be preconfigured at the UE. In some cases, the outage threshold 345 may be a percentage difference (e.g., 10% difference) between the uplink outage metric 340 and the uplink outage metric 325.

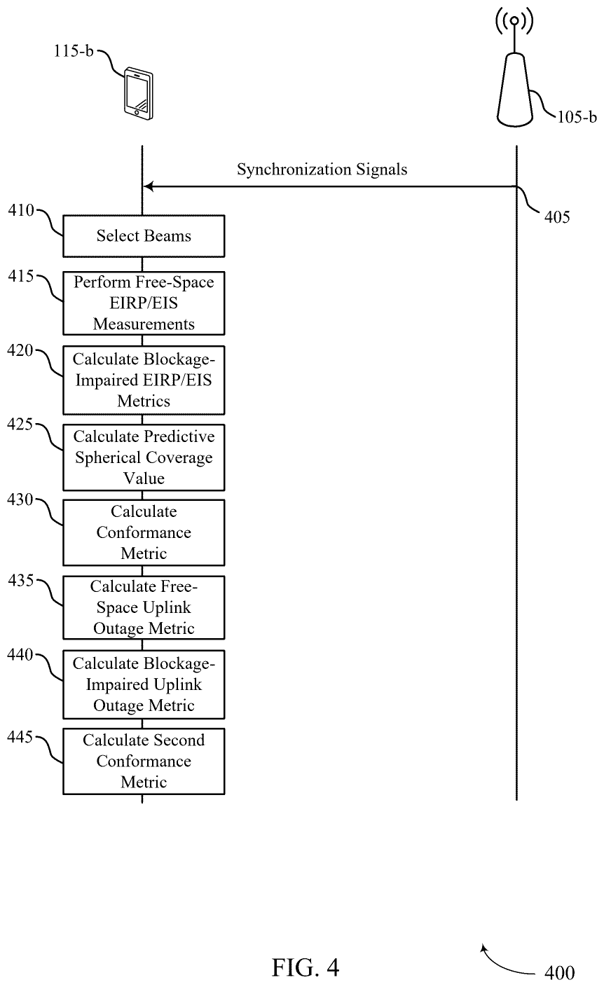

FIG. 4 shows an example of a process flow 400 that supports conformance testing for a user equipment under blockage conditions in accordance with one or more aspects of the present disclosure. For example, the process flow 400 may include a network entity 105-b which may be an example of a network entity 105 as described with reference to FIGS. 1 and 2. The process flow 400 may also include a UE 115-b that may be an example of a UE 115 as described with reference to FIGS. 1 and 2.

In the following description of process flow 400, the operations may be performed in a different order than the order shown, or other operations may be added or removed from the process flow 400. For example, some operations may also be left out of process flow 400, may be performed in different orders or at different times, or other operations may be added to process flow 400. Although communications of the process flow 400 are shown occurring between a UE 115-b and a network entity 105-b, some aspects of some operations may also be performed by one or more other wireless devices, network devices, or network functions.

At 405, the UE 115-b may receive, from the network entity 105-b, a set of beam-swept synchronization signals (e.g., SSBs) associated with a testing procedure for the UE. At 410, the UE 115-b may select a first beam pair from a set of beam pairs associated with the set of beam-swept synchronization signals. The first beam pair may correspond to a first antenna module of the UE 115-b. In some implementations, the UE 115-b may select the first beam pair based on the first beam pair having a relative highest average RSRP of the set of beam pairs.

At 415, the UE 115-b may perform one or more freespace spherical coverage measurements of the first antenna module based on selecting the first beam pair. The one or more freespace spherical coverage measurements may include at least one of an EIRP or an EIS.

At 420, the UE 115-b may calculate one or more blockage-impaired spherical coverage metrics of the first antenna module based on the one or more freespace spherical coverage measurements and a blockage transformation (e.g., a hand/body blockage transformation or function) associated with the first antenna module.

At 425, the UE 115-b may calculate a predictive spherical coverage value of the UE 115-b in a blockage environment based on the one or more blockage-impaired spherical coverage metrics of the first antenna module and one or more second blockage-impaired spherical coverage metrics of one or more other antenna modules of the UE 115-b. In some examples, the UE 115-b may perform an averaging of the one or more blockage-impaired spherical coverage metrics of the first antenna module and the one or more second blockage-impaired spherical coverage metrics of the one or more other antenna modules based on a set of candidate hand/body positions associated with a user of the UE 115-b. Each candidate hand/body position of the set of hand/body positions may be indicative of whether the first antenna module and each of the one or more other antenna modules is in a blocked state (e.g., either blocked or unblocked). Each candidate hand/body position may correspond to a respective probability, and performing the averaging may be based on the respective probability of each hand/body position.

At 430, the UE 115-b may calculate a conformance metric for the UE 115-b based on the predictive spherical coverage value of the UE 115-b in the blockage environment satisfying a threshold (e.g., a threshold EIRP/EIS, an EIRP/EIS specification). The threshold may be an existing EIRP/EIS specification that the UE 115-b may also use to test a conformance of the UE 115-b in a chamber or in a freespace condition.

At 435, the UE 115-b may calculate a freespace uplink outage metric (e.g., a freespace uplink outage probability) of the UE 115-b based on the one or more spherical coverage metric of the first antenna module, one or more second spherical coverage measurements of the one or more other antenna modules (e.g., EIRP/EIS data at each antenna module of the UE), and one or more path loss or link budget values (e.g., which may be based on a path loss or link budget model or distribution) associated with communication between the UE 115-b and the network entity 105-b. At 440, the UE 115-b may calculate a blockage-impaired uplink outage metric (e.g., a blockage-impaired uplink outage probability) of the UE 115-b based on the one or more blockage-impaired spherical coverage metrics of the first antenna module, the one or more second blockage-impaired spherical coverage metrics of the one or more other antenna modules, and the one or more path loss or link budget values.

At 445, the UE 115-b may calculate a second conformance metric of the UE 115-b based on a difference between the freespace uplink outage metric and the blockage-impaired uplink outage metric satisfying a second threshold. In some cases, the UE 115-b may pass an uplink outage conformance test in cases where the blockage-impaired uplink outage metric is within a percentage (e.g., 10%) of the freespace uplink outage metric.

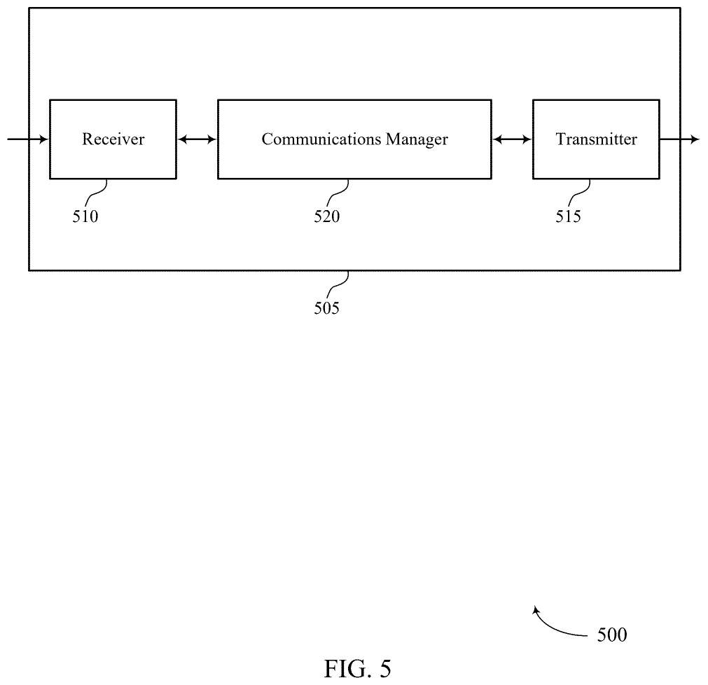

FIG. 5 shows a block diagram 500 of a device 505 that supports conformance testing for a user equipment under blockage conditions in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to conformance testing for a user equipment under blockage conditions). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to conformance testing for a user equipment under blockage conditions). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of conformance testing for a user equipment under blockage conditions as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software) executed by at least one processor. If implemented in code executed by at least one processor, the functions of the communications manager 520, the receiver 510, the transmitter 515, or various combinations or components thereof may be performed by a general-purpose processor, a DSP, a CPU, a graphics processing unit (GPU), a neural processing unit (NPU), an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving, from a network entity, a set of multiple beam-swept synchronization signals associated with a testing procedure for the UE. The communications manager 520 is capable of, configured to, or operable to support a means for selecting a first beam pair from a set of multiple beam pairs associated with the set of multiple beam-swept synchronization signals, where the first beam pair corresponds to a first antenna module of the UE. The communications manager 520 is capable of, configured to, or operable to support a means for performing one or more free-space spherical coverage measurements of the first antenna module based on selecting the first beam pair, the one or more free-space spherical coverage measurements including at least one of an EIRP or EIS. The communications manager 520 is capable of, configured to, or operable to support a means for calculating one or more blockage-impaired spherical coverage metrics of the first antenna module based on the one or more free-space spherical coverage measurements and a blockage transformation associated with the first antenna module. The communications manager 520 is capable of, configured to, or operable to support a means for calculating a predictive spherical coverage value of the UE in a blockage environment based on the one or more blockage-impaired spherical coverage metrics of the first antenna module and one or more second blockage-impaired spherical coverage metrics of one or more other antenna modules of the UE. The communications manager 520 is capable of, configured to, or operable to support a means for calculating a conformance metric for the UE based on the predictive spherical coverage value of the UE in the blockage environment satisfying a threshold.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing and reduced power consumption by determining a conformance of UEs to specifications or thresholds that take into account impacts of blockage in a field environment of the UEs.

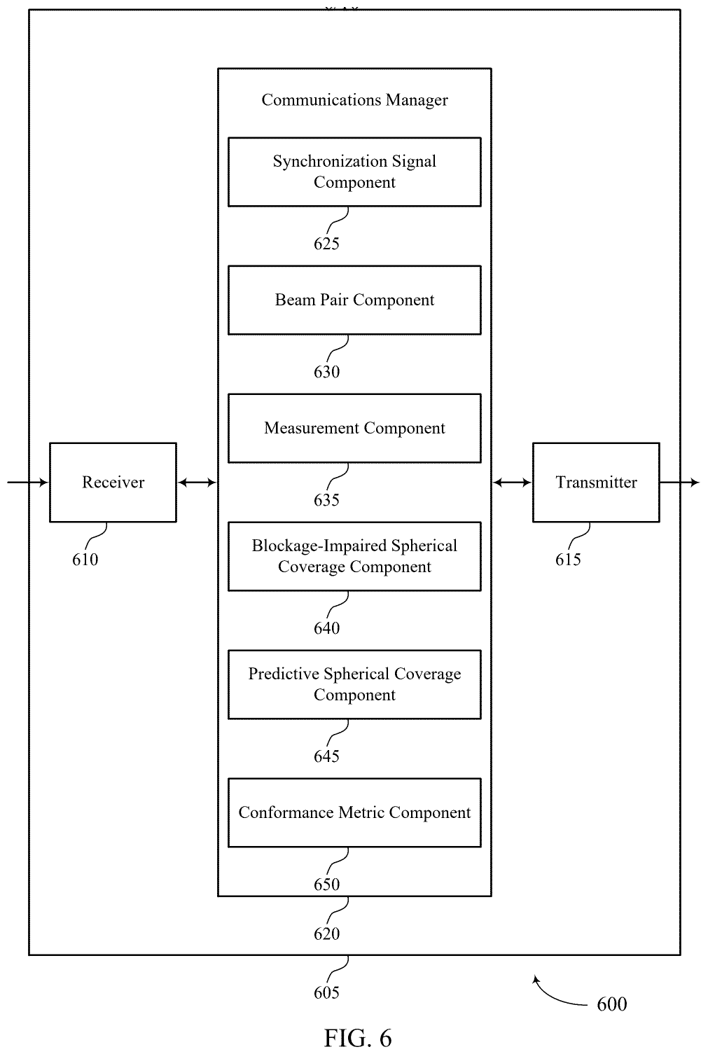

FIG. 6 shows a block diagram 600 of a device 605 that supports conformance testing for a user equipment under blockage conditions in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to conformance testing for a user equipment under blockage conditions). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to conformance testing for a user equipment under blockage conditions). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of conformance testing for a user equipment under blockage conditions as described herein. For example, the communications manager 620 may include a synchronization signal component 625, a beam pair component 630, a measurement component 635, a blockage-impaired spherical coverage component 640, a predictive spherical coverage component 645, a conformance metric component 650, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The synchronization signal component 625 is capable of, configured to, or operable to support a means for receiving, from a network entity, a set of multiple beam-swept synchronization signals associated with a testing procedure for the UE. The beam pair component 630 is capable of, configured to, or operable to support a means for selecting a first beam pair from a set of multiple beam pairs associated with the set of multiple beam-swept synchronization signals, where the first beam pair corresponds to a first antenna module of the UE. The measurement component 635 is capable of, configured to, or operable to support a means for performing one or more free-space spherical coverage measurements of the first antenna module based on selecting the first beam pair, the one or more free-space spherical coverage measurements including at least one of an EIRP or EIS. The blockage-impaired spherical coverage component 640 is capable of, configured to, or operable to support a means for calculating one or more blockage-impaired spherical coverage metrics of the first antenna module based on the one or more free-space spherical coverage measurements and a blockage transformation associated with the first antenna module. The predictive spherical coverage component 645 is capable of, configured to, or operable to support a means for calculating a predictive spherical coverage value of the UE in a blockage environment based on the one or more blockage-impaired spherical coverage metrics of the first antenna module and one or more second blockage-impaired spherical coverage metrics of one or more other antenna modules of the UE. The conformance metric component 650 is capable of, configured to, or operable to support a means for calculating a conformance metric for the UE based on the predictive spherical coverage value of the UE in the blockage environment satisfying a threshold.

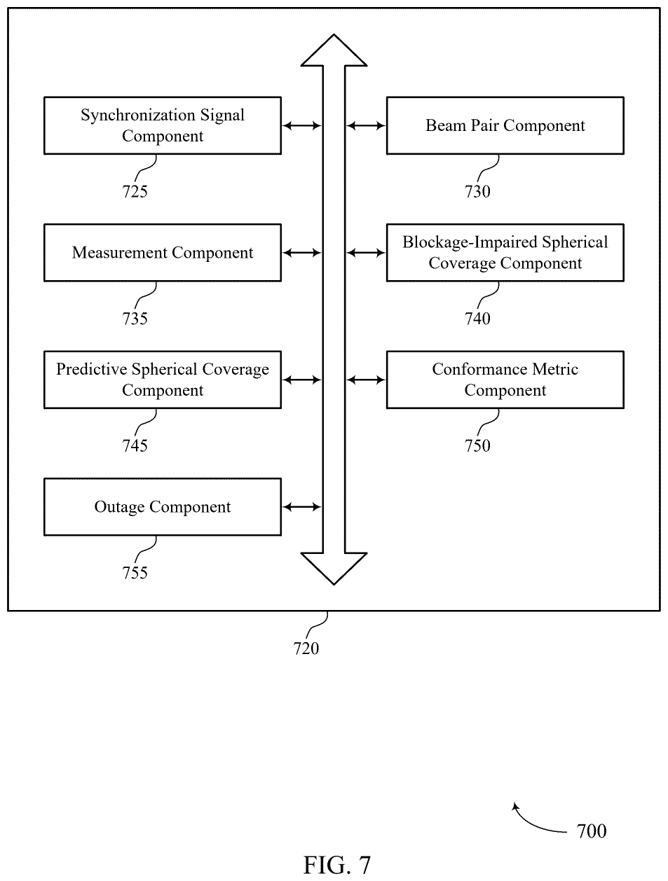

FIG. 7 shows a block diagram 700 of a communications manager 720 that supports conformance testing for a user equipment under blockage conditions in accordance with one or more aspects of the present disclosure. The communications manager 720 may be an example of aspects of a communications manager 520, a communications manager 620, or both, as described herein. The communications manager 720, or various components thereof, may be an example of means for performing various aspects of conformance testing for a user equipment under blockage conditions as described herein. For example, the communications manager 720 may include a synchronization signal component 725, a beam pair component 730, a measurement component 735, a blockage-impaired spherical coverage component 740, a predictive spherical coverage component 745, a conformance metric component 750, an outage component 755, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The synchronization signal component 725 is capable of, configured to, or operable to support a means for receiving, from a network entity, a set of multiple beam-swept synchronization signals associated with a testing procedure for the UE. The beam pair component 730 is capable of, configured to, or operable to support a means for selecting a first beam pair from a set of multiple beam pairs associated with the set of multiple beam-swept synchronization signals, where the first beam pair corresponds to a first antenna module of the UE. The measurement component 735 is capable of, configured to, or operable to support a means for performing one or more free-space spherical coverage measurements of the first antenna module based on selecting the first beam pair, the one or more free-space spherical coverage measurements including at least one of an EIRP or EIS. The blockage-impaired spherical coverage component 740 is capable of, configured to, or operable to support a means for calculating one or more blockage-impaired spherical coverage metrics of the first antenna module based on the one or more free-space spherical coverage measurements and a blockage transformation associated with the first antenna module. The predictive spherical coverage component 745 is capable of, configured to, or operable to support a means for calculating a predictive spherical coverage value of the UE in a blockage environment based on the one or more blockage-impaired spherical coverage metrics of the first antenna module and one or more second blockage-impaired spherical coverage metrics of one or more other antenna modules of the UE. The conformance metric component 750 is capable of, configured to, or operable to support a means for calculating a conformance metric for the UE based on the predictive spherical coverage value of the UE in the blockage environment satisfying a threshold.

In some examples, to support calculating the predictive spherical coverage value of the UE in the blockage environment, the predictive spherical coverage component 745 is capable of, configured to, or operable to support a means for performing an averaging of the one or more blockage-impaired spherical coverage metrics of the first antenna module and the one or more second blockage-impaired spherical coverage metrics of the one or more other antenna modules based on a set of multiple candidate hand or body positions associated with a user of the UE.

In some examples, each candidate hand or body position of the set of multiple candidate hand or body positions is indicative of whether the first antenna module and each of the one or more other antenna modules is in a blocked state.

In some examples, each candidate hand or body position of the set of multiple candidate hand or body positions corresponds to a respective probability. In some examples, performing the averaging is based on the respective probability of each candidate hand or body position.

In some examples, the outage component 755 is capable of, configured to, or operable to support a means for calculating a free-space uplink outage metric of the UE based on the one or more free-space spherical coverage measurements of the first antenna module, one or more second spherical coverage measurements of the one or more other antenna modules, and one or more path loss or link budget values associated with communication between the UE and the network entity. In some examples, the outage component 755 is capable of, configured to, or operable to support a means for calculating a blockage-impaired uplink outage metric of the UE based on the one or more blockage-impaired spherical coverage metrics of the first antenna module, the one or more second blockage-impaired spherical coverage metrics of the one or more other antenna modules, and the one or more path loss or link budget values.

In some examples, the conformance metric component 750 is capable of, configured to, or operable to support a means for calculating a second conformance metric of the UE based on a difference between the free-space uplink outage metric and the blockage-impaired uplink outage metric satisfying a second threshold.

In some examples, each of the one or more blockage-impaired spherical coverage metrics correspond to a respective portion of a spherical area surrounding the UE.

In some examples, the one or more blockage-impaired spherical coverage metrics include at least one of a second EIRP, different from the EIRP, or a second EIS, different from the EIS.

In some examples, to support selecting the first beam pair, the beam pair component 730 is capable of, configured to, or operable to support a means for selecting the first beam pair based on the first beam pair having a relative highest average reference signal received power (RSRP) of the set of multiple beam pairs.

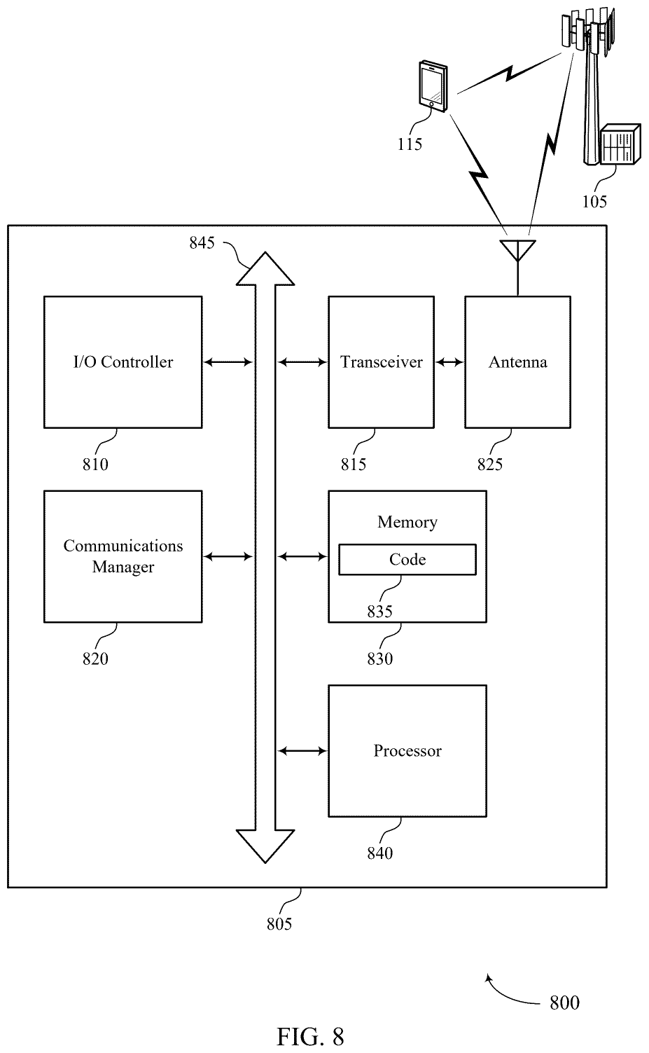

FIG. 8 shows a diagram of a system 800 including a device 805 that supports conformance testing for a user equipment under blockage conditions in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable code 835 including instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may contain, among other things, a basic I/O system (BIOS) which may control basic hardware or software operation such as the interaction with peripheral components or devices.

The at least one processor 840 may include an intelligent hardware device (e.g., a general-purpose processor, a DSP, a CPU, a GPU, a NPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting conformance testing for a user equipment under blockage conditions). For example, the device 805 or a component of the device 805 may include at least one processor 840 and at least one memory 830 coupled with or to the at least one processor 840, the at least one processor 840 and at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving, from a network entity, a set of multiple beam-swept synchronization signals associated with a testing procedure for the UE. The communications manager 820 is capable of, configured to, or operable to support a means for selecting a first beam pair from a set of multiple beam pairs associated with the set of multiple beam-swept synchronization signals, where the first beam pair corresponds to a first antenna module of the UE. The communications manager 820 is capable of, configured to, or operable to support a means for performing one or more free-space spherical coverage measurements of the first antenna module based on selecting the first beam pair, the one or more free-space spherical coverage measurements including at least one of an EIRP or EIS. The communications manager 820 is capable of, configured to, or operable to support a means for calculating one or more blockage-impaired spherical coverage metrics of the first antenna module based on the one or more free-space spherical coverage measurements and a blockage transformation associated with the first antenna module. The communications manager 820 is capable of, configured to, or operable to support a means for calculating a predictive spherical coverage value of the UE in a blockage environment based on the one or more blockage-impaired spherical coverage metrics of the first antenna module and one or more second blockage-impaired spherical coverage metrics of one or more other antenna modules of the UE. The communications manager 820 is capable of, configured to, or operable to support a means for calculating a conformance metric for the UE based on the predictive spherical coverage value of the UE in the blockage environment satisfying a threshold.

By including or configuring the communications manager 820 in accordance with examples as described herein, the device 805 may support techniques for reduced latency, reduced power consumption, and improved coordination between devices by determining a conformance of UEs to specifications or thresholds that take into account impacts of blockage in a field environment of the UEs.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of conformance testing for a user equipment under blockage conditions as described herein, or the at least one processor 840 and the at least one memory 830 may be otherwise configured to, individually or collectively, perform or support such operations.

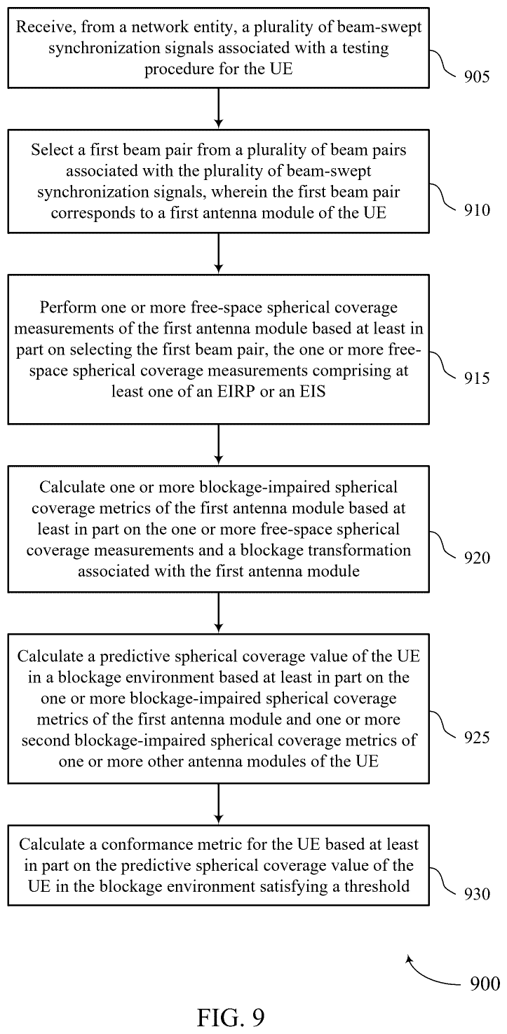

FIG. 9 shows a flowchart illustrating a method 900 that supports conformance testing for a user equipment under blockage conditions in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving, from a network entity, a plurality of beam-swept synchronization signals associated with a testing procedure for the UE. The operations of block 905 may be performed in accordance with examples as disclosed herein. In some examples, aspects of the operations of 905 may be performed by a synchronization signal component 725 as described with reference to FIG. 7.

At 910, the method may include selecting a first beam pair from a plurality of beam pairs associated with the plurality of beam-swept synchronization signals, wherein the first beam pair corresponds to a first antenna module of the UE. The operations of block 910 may be performed in accordance with examples as disclosed herein. In some examples, aspects of the operations of 910 may be performed by a beam pair component 730 as described with reference to FIG. 7.

At 915, the method may include performing one or more free-space spherical coverage measurements of the first antenna module based at least in part on selecting the first beam pair, the one or more free-space spherical coverage measurements comprising at least one of an EIRP or an EIS. The operations of block 915 may be performed in accordance with examples as disclosed herein. In some examples, aspects of the operations of 915 may be performed by a measurement component 735 as described with reference to FIG. 7.

At 920, the method may include calculating one or more blockage-impaired spherical coverage metrics of the first antenna module based at least in part on the one or more free-space spherical coverage measurements and a blockage transformation associated with the first antenna module. The operations of block 920 may be performed in accordance with examples as disclosed herein. In some examples, aspects of the operations of 920 may be performed by a blockage-impaired spherical coverage component 740 as described with reference to FIG. 7.

At 925, the method may include calculating a predictive spherical coverage value of the UE in a blockage environment based at least in part on the one or more blockage-impaired spherical coverage metrics of the first antenna module and one or more second blockage-impaired spherical coverage metrics of one or more other antenna modules of the UE. The operations of block 925 may be performed in accordance with examples as disclosed herein. In some examples, aspects of the operations of 925 may be performed by a predictive spherical coverage component 745 as described with reference to FIG. 7.

At 930, the method may include calculating a conformance metric for the UE based at least in part on the predictive spherical coverage value of the UE in the blockage environment satisfying a threshold. The operations of block 930 may be performed in accordance with examples as disclosed herein. In some examples, aspects of the operations of 930 may be performed by a conformance metric component 750 as described with reference to FIG. 7.

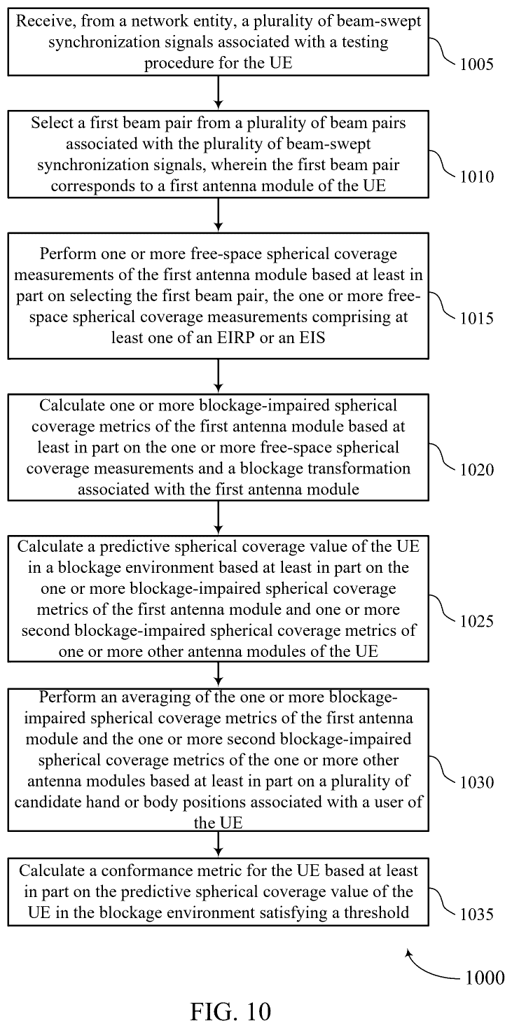

FIG. 10 shows a flowchart illustrating a method 1000 that supports conformance testing for a user equipment under blockage conditions in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include receiving, from a network entity, a plurality of beam-swept synchronization signals associated with a testing procedure for the UE. The operations of block 1005 may be performed in accordance with examples as disclosed herein. In some examples, aspects of the operations of 1005 may be performed by a synchronization signal component 725 as described with reference to FIG. 7.

At 1010, the method may include selecting a first beam pair from a plurality of beam pairs associated with the plurality of beam-swept synchronization signals, wherein the first beam pair corresponds to a first antenna module of the UE. The operations of block 1010 may be performed in accordance with examples as disclosed herein. In some examples, aspects of the operations of 1010 may be performed by a beam pair component 730 as described with reference to FIG. 7.

At 1015, the method may include performing one or more free-space spherical coverage measurements of the first antenna module based at least in part on selecting the first beam pair, the one or more free-space spherical coverage measurements comprising at least one of an EIRP or EIS. The operations of block 1015 may be performed in accordance with examples as disclosed herein. In some examples, aspects of the operations of 1015 may be performed by a measurement component 735 as described with reference to FIG. 7.

At 1020, the method may include calculating one or more blockage-impaired spherical coverage metrics of the first antenna module based at least in part on the one or more free-space spherical coverage measurements and a blockage transformation associated with the first antenna module. The operations of block 1020 may be performed in accordance with examples as disclosed herein. In some examples, aspects of the operations of 1020 may be performed by a blockage-impaired spherical coverage component 740 as described with reference to FIG. 7.

At 1025, the method may include calculating a predictive spherical coverage value of the UE in a blockage environment based at least in part on the one or more blockage-impaired spherical coverage metrics of the first antenna module and one or more second blockage-impaired spherical coverage metrics of one or more other antenna modules of the UE. The operations of block 1025 may be performed in accordance with examples as disclosed herein. In some examples, aspects of the operations of 1025 may be performed by a predictive spherical coverage component 745 as described with reference to FIG. 7.

At 1030, the method may include performing an averaging of the one or more blockage-impaired spherical coverage metrics of the first antenna module and the one or more second blockage-impaired spherical coverage metrics of the one or more other antenna modules based at least in part on a plurality of candidate hand or body positions associated with a user of the UE. The operations of block 1030 may be performed in accordance with examples as disclosed herein. In some examples, aspects of the operations of 1030 may be performed by a predictive spherical coverage component 745 as described with reference to FIG. 7.

At 1035, the method may include calculating a conformance metric for the UE based at least in part on the predictive spherical coverage value of the UE in the blockage environment satisfying a threshold. The operations of block 1035 may be performed in accordance with examples as disclosed herein. In some examples, aspects of the operations of 1035 may be performed by a conformance metric component 750 as described with reference to FIG. 7.

The following provides an overview of aspects of the present disclosure:

Aspect 1: A method for wireless communications at a UE, comprising: receiving, from a network entity, a plurality of beam-swept synchronization signals associated with a testing procedure for the UE; selecting a first beam pair from a plurality of beam pairs associated with the plurality of beam-swept synchronization signals, wherein the first beam pair corresponds to a first antenna module of the UE; performing one or more free-space spherical coverage measurements of the first antenna module based at least in part on selecting the first beam pair, the one or more free-space spherical coverage measurements comprising at least one of an EIRP or an EIS; calculating one or more blockage-impaired spherical coverage metrics of the first antenna module based at least in part on the one or more free-space spherical coverage measurements and a blockage transformation associated with the first antenna module; calculating a predictive spherical coverage value of the UE in a blockage environment based at least in part on the one or more blockage-impaired spherical coverage metrics of the first antenna module and one or more second blockage-impaired spherical coverage metrics of one or more other antenna modules of the UE; and calculating a conformance metric for the UE based at least in part on the predictive spherical coverage value of the UE in the blockage environment satisfying a threshold.

Aspect 2: The method of aspect 1, wherein calculating the predictive spherical coverage value of the UE in the blockage environment comprises: performing an averaging of the one or more blockage-impaired spherical coverage metrics of the first antenna module and the one or more second blockage-impaired spherical coverage metrics of the one or more other antenna modules based at least in part on a plurality of candidate hand or body positions associated with a user of the UE.

Aspect 3: The method of aspect 2, wherein each candidate hand or body position of the plurality of candidate hand or body positions is indicative of whether the first antenna module and each of the one or more other antenna modules is in a blocked state.

Aspect 4: The method of any of aspects 2 through 3, wherein each candidate hand or body position of the plurality of candidate hand or body positions corresponds to a respective probability, and performing the averaging is based at least in part on the respective probability of each candidate hand or body position.

Aspect 5: The method of any of aspects 1 through 4, further comprising: calculating a free-space uplink outage metric of the UE based at least in part on the one or more free-space spherical coverage measurements of the first antenna module, one or more second spherical coverage measurements of the one or more other antenna modules, and one or more path loss or link budget values associated with communication between the UE and the network entity; and calculating a blockage-impaired uplink outage metric of the UE based at least in part on the one or more blockage-impaired spherical coverage metrics of the first antenna module, the one or more second blockage-impaired spherical coverage metrics of the one or more other antenna modules, and the one or more path loss or link budget values.

Aspect 6: The method of aspect 5, further comprising: calculating a second conformance metric of the UE based at least in part on a difference between the free-space uplink outage metric and the blockage-impaired uplink outage metric satisfying a second threshold.

Aspect 7: The method of any of aspects 1 through 6, wherein each of the one or more blockage-impaired spherical coverage metrics correspond to a respective portion of a spherical area surrounding the UE.

Aspect 8: The method of any of aspects 1 through 7, wherein the one or more blockage-impaired spherical coverage metrics comprise at least one of a second EIRP, different from the EIRP, or a second EIS, different from the EIS.

Aspect 9: The method of any of aspects 1 through 8, wherein selecting the first beam pair comprises: selecting the first beam pair based at least in part on the first beam pair having a relative highest average RSRP of the plurality of beam pairs.

Aspect 10: A UE for wireless communications, comprising one or more memories storing processor-executable code, and one or more processors coupled with (e.g., operatively, communicatively, functionally, electronically, or electrically) the one or more memories and individually or collectively operable to execute the code (e.g., directly, indirectly, after pre-processing, without pre-processing) to cause the UE to perform a method of any of aspects 1 through 9.

Aspect 11: A UE for wireless communications, comprising at least one means for performing a method of any of aspects 1 through 9.

Aspect 12: A non-transitory computer-readable medium storing code for wireless communications, the code comprising instructions executable by one or more processors (e.g., directly, indirectly, after pre-processing, without pre-processing) to perform a method of any of aspects 1 through 9.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, a NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, from a network entity, a plurality of beam-swept synchronization signals associated with a testing procedure for the UE;
select a first beam pair from a plurality of beam pairs associated with the plurality of beam-swept synchronization signals, wherein the first beam pair corresponds to a first antenna module of the UE;
perform one or more free-space spherical coverage measurements of the first antenna module based at least in part on selecting the first beam pair, the one or more free-space spherical coverage measurements comprising at least one of an equivalent isotropic radiated power (EIRP) or an effective isotropic sensitivity (EIS);
calculate one or more blockage-impaired spherical coverage metrics of the first antenna module based at least in part on the one or more free-space spherical coverage measurements and a blockage transformation associated with the first antenna module;
calculate a predictive spherical coverage value of the UE in a blockage environment based at least in part on the one or more blockage-impaired spherical coverage metrics of the first antenna module and one or more second blockage-impaired spherical coverage metrics of one or more other antenna modules of the UE; and
calculate a conformance metric for the UE based at least in part on the predictive spherical coverage value of the UE in the blockage environment satisfying a threshold.

2. The UE of claim 1, wherein, to calculate the predictive spherical coverage value of the UE in the blockage environment, the one or more processors are individually or collectively operable to execute the code to cause the UE to:
perform an averaging of the one or more blockage-impaired spherical coverage metrics of the first antenna module and the one or more second blockage-impaired spherical coverage metrics of the one or more other antenna modules based at least in part on a plurality of candidate hand or body positions associated with a user of the UE.

3. The UE of claim 2, wherein each candidate hand or body position of the plurality of candidate hand or body positions is indicative of whether the first antenna module and each of the one or more other antenna modules is in a blocked state.

4. The UE of claim 2, wherein:
each candidate hand or body position of the plurality of candidate hand or body positions corresponds to a respective probability, and
performing the averaging is based at least in part on the respective probability of each candidate hand or body position.

5. The UE of claim 1, wherein the one or more processors are individually or collectively further operable to execute the code to cause the UE to:
calculate a free-space uplink outage metric of the UE based at least in part on the one or more free-space spherical coverage measurements of the first antenna module, one or more second spherical coverage measurements of the one or more other antenna modules, and one or more path loss or link budget values associated with communication between the UE and the network entity; and
calculate a blockage-impaired uplink outage metric of the UE based at least in part on the one or more blockage-impaired spherical coverage metrics of the first antenna module, the one or more second blockage-impaired spherical coverage metrics of the one or more other antenna modules, and the one or more path loss or link budget values.

6. The UE of claim 5, wherein the one or more processors are individually or collectively further operable to execute the code to cause the UE to:
calculate a second conformance metric of the UE based at least in part on a difference between the free-space uplink outage metric and the blockage-impaired uplink outage metric satisfying a second threshold.

7. The UE of claim 1, wherein each of the one or more blockage-impaired spherical coverage metrics correspond to a respective portion of a spherical area surrounding the UE.

8. The UE of claim 1, wherein the one or more blockage-impaired spherical coverage metrics comprise at least one of a second EIRP, different from the EIRP, or a second EIS, different from the EIS.

9. The UE of claim 1, wherein, to select the first beam pair, the one or more processors are individually or collectively operable to execute the code to cause the UE to:
select the first beam pair based at least in part on the first beam pair having a relative highest average reference signal received power (RSRP) of the plurality of beam pairs.

10. A method for wireless communications at a user equipment (UE), comprising:
receiving, from a network entity, a plurality of beam-swept synchronization signals associated with a testing procedure for the UE;
selecting a first beam pair from a plurality of beam pairs associated with the plurality of beam-swept synchronization signals, wherein the first beam pair corresponds to a first antenna module of the UE;
performing one or more free-space spherical coverage measurements of the first antenna module based at least in part on selecting the first beam pair, the one or more free-space spherical coverage measurements comprising at least one of an equivalent isotropic radiated power (EIRP) or an effective isotropic sensitivity (EIS);
calculating one or more blockage-impaired spherical coverage metrics of the first antenna module based at least in part on the one or more free-space spherical coverage measurements and a blockage transformation associated with the first antenna module;
calculating a predictive spherical coverage value of the UE in a blockage environment based at least in part on the one or more blockage-impaired spherical coverage metrics of the first antenna module and one or more second blockage-impaired spherical coverage metrics of one or more other antenna modules of the UE; and
calculating a conformance metric for the UE based at least in part on the predictive spherical coverage value of the UE in the blockage environment satisfying a threshold.

11. The method of claim 10, wherein calculating the predictive spherical coverage value of the UE in the blockage environment comprises:
performing an averaging of the one or more blockage-impaired spherical coverage metrics of the first antenna module and the one or more second blockage-impaired spherical coverage metrics of the one or more other antenna modules based at least in part on a plurality of candidate hand or body positions associated with a user of the UE.

12. The method of claim 11, wherein each candidate hand or body position of the plurality of candidate hand or body positions is indicative of whether the first antenna module and each of the one or more other antenna modules is in a blocked state.

13. The method of claim 11, wherein:
each candidate hand or body position of the plurality of candidate hand or body positions corresponds to a respective probability, and
performing the averaging is based at least in part on the respective probability of each candidate hand or body position.

14. The method of claim 10, further comprising:
calculating a free-space uplink outage metric of the UE based at least in part on the one or more free-space spherical coverage measurements of the first antenna module, one or more second spherical coverage measurements of the one or more other antenna modules, and one or more path loss or link budget values associated with communication between the UE and the network entity; and
calculating a blockage-impaired uplink outage metric of the UE based at least in part on the one or more blockage-impaired spherical coverage metrics of the first antenna module, the one or more second blockage-impaired spherical coverage metrics of the one or more other antenna modules, and the one or more path loss or link budget values.

15. The method of claim 14, further comprising:
calculating a second conformance metric of the UE based at least in part on a difference between the free-space uplink outage metric and the blockage-impaired uplink outage metric satisfying a second threshold.

16. The method of claim 10, wherein each of the one or more blockage-impaired spherical coverage metrics correspond to a respective portion of a spherical area surrounding the UE.

17. The method of claim 10, wherein the one or more blockage-impaired spherical coverage metrics comprise at least one of a second EIRP, different from the EIRP, or a second EIS, different from the EIS.

18. The method of claim 10, wherein selecting the first beam pair comprises:
selecting the first beam pair based at least in part on the first beam pair having a relative highest average reference signal received power (RSRP) of the plurality of beam pairs.

19. A user equipment (UE) for wireless communications, comprising:
means for receiving, from a network entity, a plurality of beam-swept synchronization signals associated with a testing procedure for the UE;
means for selecting a first beam pair from a plurality of beam pairs associated with the plurality of beam-swept synchronization signals, wherein the first beam pair corresponds to a first antenna module of the UE;
means for performing one or more free-space spherical coverage measurements of the first antenna module based at least in part on selecting the first beam pair, the one or more free-space spherical coverage measurements comprising at least one of an equivalent isotropic radiated power (EIRP) or an effective isotropic sensitivity (EIS);
means for calculating one or more blockage-impaired spherical coverage metrics of the first antenna module based at least in part on the one or more free-space spherical coverage measurements and a blockage transformation associated with the first antenna module;
means for calculating a predictive spherical coverage value of the UE in a blockage environment based at least in part on the one or more blockage-impaired spherical coverage metrics of the first antenna module and one or more second blockage-impaired spherical coverage metrics of one or more other antenna modules of the UE; and
means for calculating a conformance metric for the UE based at least in part on the predictive spherical coverage value of the UE in the blockage environment satisfying a threshold.

20. The UE of claim 19, wherein the means for calculating the predictive spherical coverage value of the UE in the blockage environment comprise:
means for performing an averaging of the one or more blockage-impaired spherical coverage metrics of the first antenna module and the one or more second blockage-impaired spherical coverage metrics of the one or more other antenna modules based at least in part on a plurality of candidate hand or body positions associated with a user of the UE.

21. The UE of claim 20, wherein each candidate hand or body position of the plurality of candidate hand or body positions is indicative of whether the first antenna module and each of the one or more other antenna modules is in a blocked state.

22. The UE of claim 20, wherein:
each candidate hand or body position of the plurality of candidate hand or body positions corresponds to a respective probability, and
performing the averaging is based at least in part on the respective probability of each candidate hand or body position.

23. The UE of claim 19, further comprising:
means for calculating a free-space uplink outage metric of the UE based at least in part on the one or more free-space spherical coverage measurements of the first antenna module, one or more second spherical coverage measurements of the one or more other antenna modules, and one or more path loss or link budget values associated with communication between the UE and the network entity; and
means for calculating a blockage-impaired uplink outage metric of the UE based at least in part on the one or more blockage-impaired spherical coverage metrics of the first antenna module, the one or more second blockage-impaired spherical coverage metrics of the one or more other antenna modules, and the one or more path loss or link budget values.

24. The UE of claim 23, further comprising:
means for calculating a second conformance metric of the UE based at least in part on a difference between the free-space uplink outage metric and the blockage-impaired uplink outage metric satisfying a second threshold.

25. The UE of claim 19, wherein each of the one or more blockage-impaired spherical coverage metrics correspond to a respective portion of a spherical area surrounding the UE.

26. The UE of claim 19, wherein:
the one or more blockage-impaired spherical coverage metrics comprise at least one of a second EIRP, different from the EIRP, or a second EIS, different from the EIS.

27. The UE of claim 19, wherein the means for selecting the first beam pair comprise:
means for selecting the first beam pair based at least in part on the first beam pair having a relative highest average reference signal received power (RSRP) of the plurality of beam pairs.

28. A non-transitory computer-readable medium storing code for wireless communications, the code comprising instructions executable by one or more processors to:
receive, from a network entity, a plurality of beam-swept synchronization signals associated with a testing procedure for a UE;
select a first beam pair from a plurality of beam pairs associated with the plurality of beam-swept synchronization signals, wherein the first beam pair corresponds to a first antenna module of the UE;
perform one or more free-space spherical coverage measurements of the first antenna module based at least in part on selecting the first beam pair, the one or more free-space spherical coverage measurements comprising at least one of an equivalent isotropic radiated power (EIRP) or an effective isotropic sensitivity (EIS);
calculate one or more blockage-impaired spherical coverage metrics of the first antenna module based at least in part on the one or more free-space spherical coverage measurements and a blockage transformation associated with the first antenna module;
calculate a predictive spherical coverage value of the UE in a blockage environment based at least in part on the one or more blockage-impaired spherical coverage metrics of the first antenna module and one or more second blockage-impaired spherical coverage metrics of one or more other antenna modules of the UE; and
calculate a conformance metric for the UE based at least in part on the predictive spherical coverage value of the UE in the blockage environment satisfying a threshold.

29. The non-transitory computer-readable medium of claim 28, wherein the instructions to calculate the predictive spherical coverage value of the UE in the blockage environment are executable by the one or more processors to:
perform an averaging of the one or more blockage-impaired spherical coverage metrics of the first antenna module and the one or more second blockage-impaired spherical coverage metrics of the one or more other antenna modules based at least in part on a plurality of candidate hand or body positions associated with a user of the UE.

30. The non-transitory computer-readable medium of claim 29, wherein each candidate hand or body position of the plurality of candidate hand or body positions is indicative of whether the first antenna module and each of the one or more other antenna modules is in a blocked state.
